(19) United States
(12) Patent Application Publication
(10) Pub. No.: US 2010/0306814 A1
(43) Pub. Date: Dec. 2, 2010

(54) Integrated Set-Top Box with Daisy-Chaining

(75) Inventors: Francesco GATTA, Laguna Niguel, CA (US); Leonard Dauphinee, Costa Mesa, CA (US); Ramon Gomez, San Juan Capistrano, CA (US); Joseph L. Laskowski, Newport Coast, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 12/504,541

(22) Filed: Jul. 16, 2009

Related U.S. Application Data
(60) Provisional application No. 61/181,164, filed on May 26, 2009.

(51) Int. Cl. H04N 7/173

(52) U.S. Cl. 725/127; 725/134

(57) ABSTRACT

The present invention is an integrated set-top box having daisy-chaining capability. The set-top box includes a down-stream path having a tuner and a digital receiver portion and an up-stream path having a power amplifier. In one embodiment, the tuner, digital receiver, and power amplifier can all be disposed on a common substrate. In another embodiment, the tuner can be disposed on a first substrate, and the digital receiver and the power amplifier can be disposed on a second substrate. The set-top box includes a daisy-chain buffer having an input coupled to an input of the tuner and having an output coupled to an input of another receiving entity such as another set-top box, tuner, cable, etc., where the daisy-chain buffer is configured to provide a signal to drive the receiving entity.

### CROSS REFERENCE TO RELATED APPLICATIONS

This application claims the benefit of U.S. Provisional Patent Application No. 61/181,164, filed on May 26, 2009, which is incorporated herein by reference in its entirety.

### BACKGROUND

1. Field of the Invention

The present invention generally relates to an integrated set-top box that is configured on a common integrated circuit (IC) substrate, such as a silicon substrate.

2. Background Art

Television signals are transmitted at radio frequencies (RF) using terrestrial, cable, or satellite transmission schemes. Terrestrial and cable TV signals are typically transmitted at frequencies of approximately 54 to 860 MHz, with 6 MHz channel spacings in the United States and 8 MHz channel spacings in Europe. Satellite TV signals are typically transmitted at frequencies of approximately 980 to 2180 MHz.

Regardless of the transmission scheme, a tuner is utilized to select and down-convert a desired channel from the TV signal to an intermediate frequency (IF) signal or a baseband signal, which is suitable for processing and display on a TV or computer screen. The tuner should provide sufficient image rejection and channel selection during down-conversion as is necessary for a specific application. Historically, the National Television Standards Committee (NTSC) sets standards for television signal transmission, reception, and display. To process an NTSC signal, it is preferable that the tuner have a high-level of image rejection. However, more or less image rejection can be required for non-NTSC signals depending on the specific application and the corresponding display requirements. The output of the tuner can be coupled to a cable modem or to an integrated set-top box.

Furthermore, in a cable modem or a set-top box, the up-stream path typically includes a power amplifier to amplify the up-stream signal from the user for transmission over the cable.

In conventional systems, both the tuner IC and the power amplifier IC are typically implemented on separate substrates from the digital portions of the cable modem IC or the set-top box IC. Therefore, a cable modem assembly typically includes at least 3 substrates, namely, the tuner IC, the power amplifier IC, and the cable modem IC.

It is also desirable to allow multiple set-top boxes to be cascaded together without the added costs of using multiple low noise amplifiers (LNAs) or a more expensive LNA with multiple outputs.

What is needed is a single chip configuration for a cable modem or a set-top box so that the tuner and the upstream power amplifier are integrated with the digital portions of cable modem or the set-top box, so as to improve integration of the aforementioned ICs, with capability of cascading multiple set-top boxes in a cost-effective manner.

### BRIEF SUMMARY

An integrated set-top box having daisy-chaining capability is presented. In an embodiment, the set-top box includes a down-stream path having a tuner and a digital receiver portion and an up-stream path having a power amplifier. In one embodiment, the tuner, digital receiver, and power amplifier are all disposed on a common substrate. In another embodiment, the tuner can be disposed on a first substrate, and the digital receiver and the power amplifier can be disposed on a second substrate. The set-top box includes a daisy-chain buffer that receives an RF-input signal and has an input coupled to an input of the tuner, and has an output coupled to an input of another receiving entity such as another set-top box, tuner, cable, etc., where the daisy-chain buffer is configured to provide a signal to drive the receiving entity.

In an embodiment, a television receiver system includes two or more set-top boxes as described above. In an embodiment, the daisy-chain buffer has an input coupled to an input of a tuner of a first set-top box of the two or more set-top boxes and has an output coupled to an input of a second set-top box of the two or more set-top boxes, where the daisy-chain buffer is configured to provide a signal to drive the second set-top box.

In an embodiment, a set-top box includes a tuner and a daisy-chain buffer. The daisy-chain buffer has an input coupled to an input of the tuner and an output capable of being coupled to an input of an additional receiving entity, such as another set-top box, an integrated tuner, an isolated tuner, a television, or a cable.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates a conventional set-top box.

FIG. 2 illustrates an integrated set-top box according to embodiments of the present invention.

FIGS. 3A-3C illustrates an integrated set-top box on a common carrier, according to embodiments of the present invention.

FIGS. 4A-4B illustrate a dual conversion tuner.

FIG. 5 illustrates a single conversion tuner having I/Q correction, according to embodiments of the present invention.

FIG. 6 illustrates a single conversion tuner having frequency correction, according to embodiments of the present invention.

FIG. 7 illustrates a direct conversion tuner having I/Q correction using an equalizer circuit.

FIG. 8 illustrates first embodiment of the equalizer used in the direct conversion tuner, the equalizer having a non-decision directed stage and a decision directed stage.

FIG. 9 illustrates a second embodiment of the equalizer used in the direct conversion tuner, the equalizer having only a non-decision directed stage.

FIG. 10 illustrates a third embodiment of equalizer used in the single conversion tuner, the equalizer having only a decision directed stage.

FIG. 11 illustrates a direct-conversion tuner and a daisy-chain buffer for cascading of additional receiving devices, according to an embodiment of the present invention.

FIG. 12 illustrates a daisy-chain buffer disposed on a tuner substrate, according to an embodiment of the present invention.

FIG. 13 illustrates cascaded set-top box chips, according to an embodiment of the present invention.

FIGS. 14 and 15 are flowcharts illustrating methods of manufacturing a set-top box.

### DETAILED DESCRIPTION OF THE EMBODIMENTS

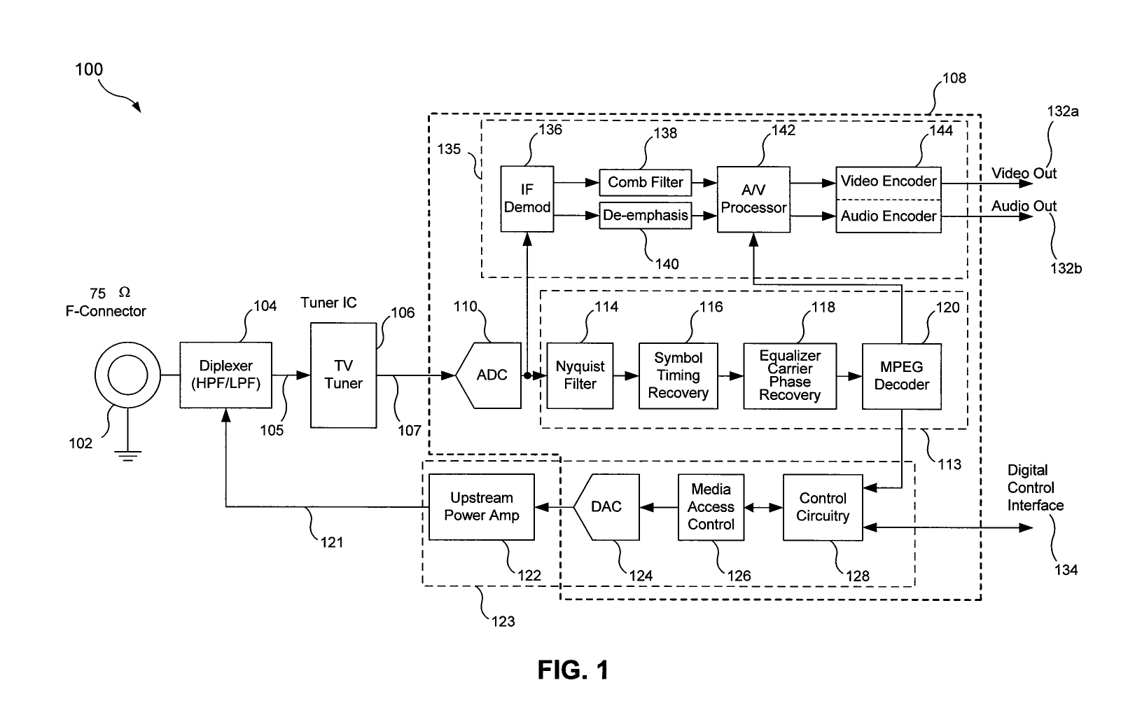

FIG. 1 illustrates a schematic of a conventional set-top box assembly 100 that transmits and receives data over a cable system (e.g., a cable TV system). The set-top box 100 provides digital communications for the home user and/or cable TV reception for standard television programming. For example, the set-top box 100 provides TV video output 132a and audio TV output 132b, according to a number of formats. The set-top box may also provide communications through the digital control interface 134. For instance, the digital control interface 134 can be used for television or movie programming and selection, etc., including TiVo®-like or video on-demand applications.

The set-top box assembly 100 includes a diplexer 104, a tuner IC 106, and a set-top box IC 108. The diplexer 104 is connected to the cable 102 and separates a down-stream signal 105 from an up-stream signal 121. The down-stream signal 105 carries data and information (e.g., TV programming or internet service) from a cable head-end to the set-top box assembly 100. The up-stream signal 121 carries user data and information from the set-top box assembly 100 to the cable head-end. For instance, the up-stream signal 121 may include programming selection.

The tuner IC 106, an up-stream power amplifier 122, and the set-top box IC 108 are conventionally on separate integrated circuits. In other words, the tuner IC 106 and the power amplifier 122 are not conventionally integrated on the same substrate with the set-top box IC 108 due to size and complexity. Furthermore, the separate substrates make it easier to separate the analog functions of the tuner IC 106 and the power amplifier 122 from the digital functions of the set-top box IC 108, and therefore preclude interference.

During down-stream operation, the tuner 106 receives the down-stream signal 105 having multiple channels and down-converts a selected channel to an IF frequency, to produce an IF signal 107. For instance, the down-stream signal 105 can include multiple TV channels that typically have 6 MHz frequency spacings and cover a range of 54-860 MHz, and where a selected channel is down-converted to an IF frequency at 44 MHz, 36 MHz or some other desired IF frequency for further processing. The selected channel is then output as an IF signal 107 to the set-top box IC 108 for further processing. The frequencies listed herein are not meant as a limitation and are provided for example purposes only.

The down-stream path of the set-top box 108 includes an analog-to-digital converter (ADC) 110, a first digital receiver portion 113, and a second digital receiver portion 135. The first digital receiver portion 113 of the down-stream path is coupled to the output of the ADC 110 and includes a Nyquist filter 114, a symbol timing recovery circuit 116, an equalizer 118, and a Motion Picture Expert Group (MPEG) decoder 120. The second digital receiver portion 135 is also coupled to the output of the ADC 110 and includes an IF demod 136, a comb filter 138, a de-emphasis 140, an audio/video (A/V) processor 142, and a video-audio encoder 144 that produces the TV audio and video outputs 132a and 132b. The first digital receiver portion 113 provides digital signal demodulation, for example, Quadrature Amplitude Modulation (QAM), where the output of the MPEG decoder 120 is coupled to the A/V processor 142 for further processing. The second digital receiver portion 135 supports NTSC demodulation and provides the audio and video outputs 132a and 132b for user display.

An up-stream path 123 of the set-top box 108 includes an up-stream power amplifier 122, a digital-to-analog converter (DAC) 124, a media access control (MAC) 126, and control circuitry 128.

During down-stream operation, the ADC 110 receives the IF signal 107 that is output from the tuner IC 106 and digitizes the IF signal 107. The elements of the first digital receiver portion 113 (the Nyquist filter 114, the symbol timing recovery 116, the equalizer 118, and the MPEG decoder 120) perform their respective signal processing functions, and output to the control circuitry 128 and the A/V processor 142. For example, the first receiver portion 113 could perform digital signal demodulation, including QAM demodulation, or some other type of demodulation. The output of the MPEG decoder 120 is further processed by the A/V processor 142 and the video-audio encoder 144 to generate the audio and video outputs 132a and 132b. In one embodiment, the output of the MPEG decoder 120 is further processed by the control circuitry 128 to communicate programming controls via the digital control interface 134.

Further, during down-stream operation, the output of the ADC 110 is also parallel processed by the second digital receiver portion 135 (having elements 136-144) to produce the standard video and audio TV outputs 132a and 132b. For example, standard NTSC signals can be processed and displayed using the second digital receiver portion 135.

For up-stream processing, the set-top box IC 108 receives transmit information from the user via the digital control interface 134. The control circuitry 128, the MAC 126 and the DAC 124 perform their respective signal processing prior to power amplification by the power amplifier 122 to produce the up-stream signal 121. As discussed above, it is noted that the up-stream power amplifier 122 is external to the set-top box IC 108 and therefore requires assembly.

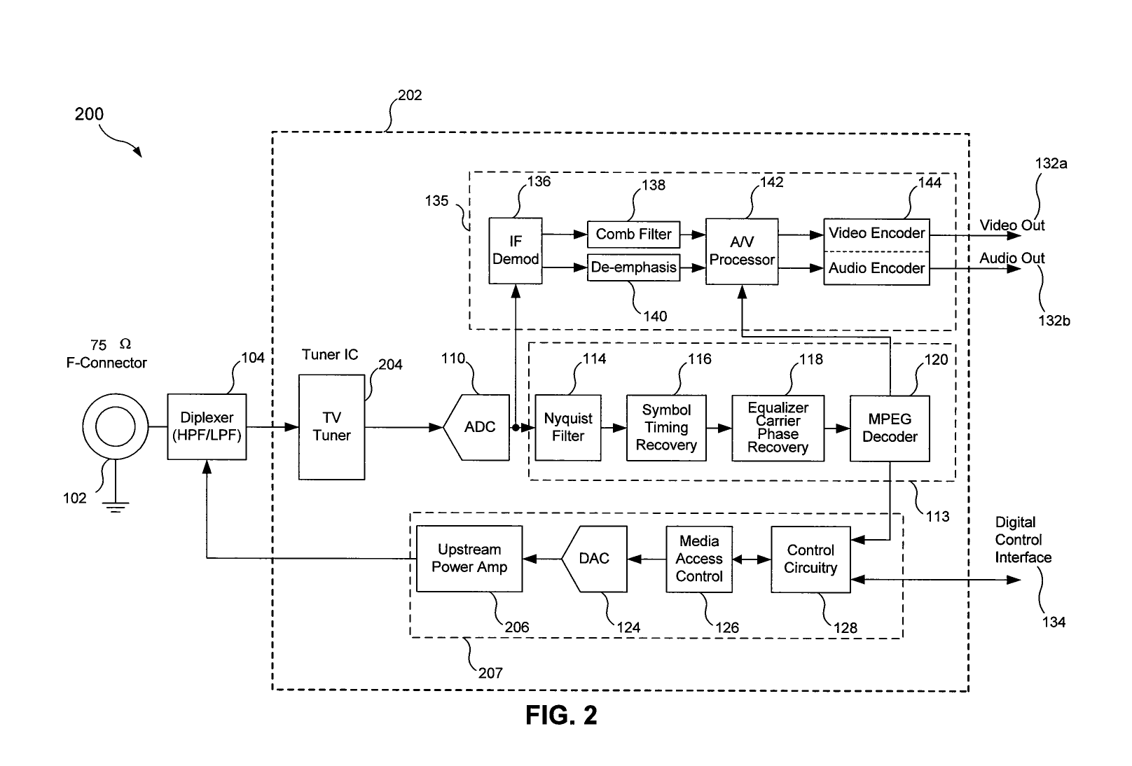

FIG. 2 illustrates a set-top box assembly 200 according to an embodiment of the invention. The set-top box assembly 200 includes the diplexer 104, and a set-top box IC 202. The set-top box IC 202 includes a TV tuner 204 and an up-stream power amplifier 206 that are integrated on a common substrate that defines the set-top box IC 202. For instance, the set-top box IC 202 is a common substrate (e.g., a silicon substrate) having the TV tuner 204 and the up-stream power amplifier 206 of an up-stream path 207 integrated with the set-top box digital functions that were illustrated in the IC 108.

There are numerous advantages to the single chip set-top box 200 shown in FIG. 2. Namely, there is no assembly needed to connect the power amplifier 206 and the TV tuner 204 to the digital functions of the set-top box IC 202. In other words, the high level of integration reduces or eliminates bond wire connections between the noted components. Bondwires and other inter-chip connections have electrical parasitics that reduce the performance of the set-top box tuner 100. Therefore, the single chip set-top box IC 202 has both performance as well as economic advantages over the configuration that was shown in FIG. 1.

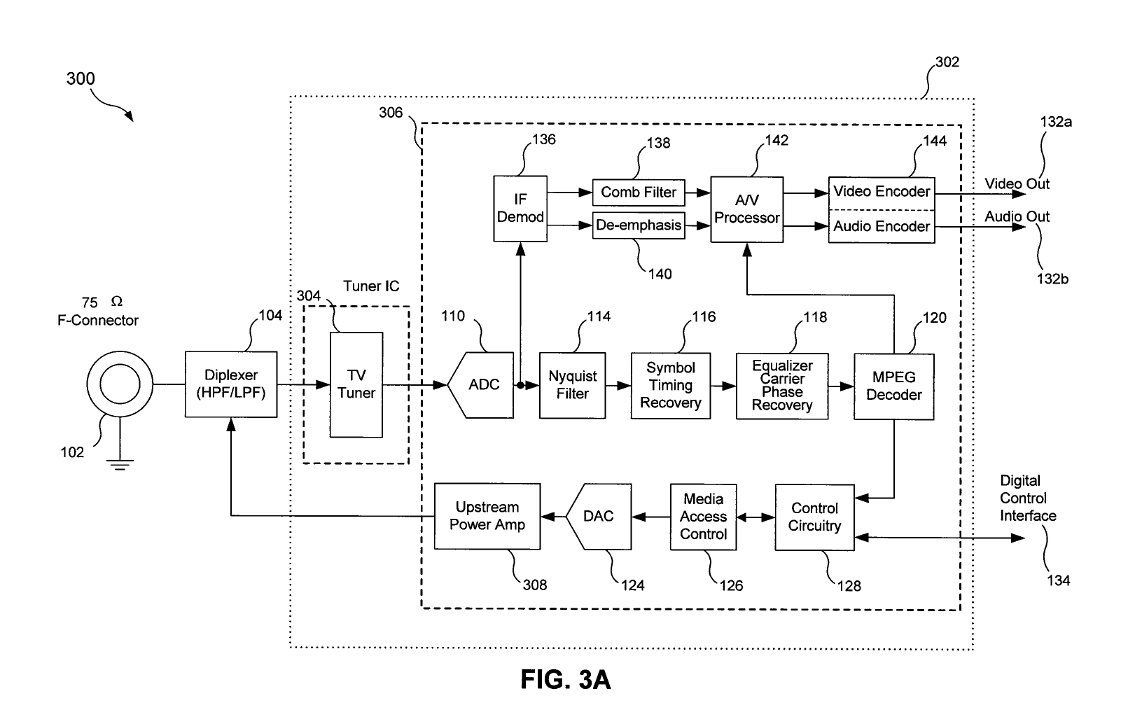

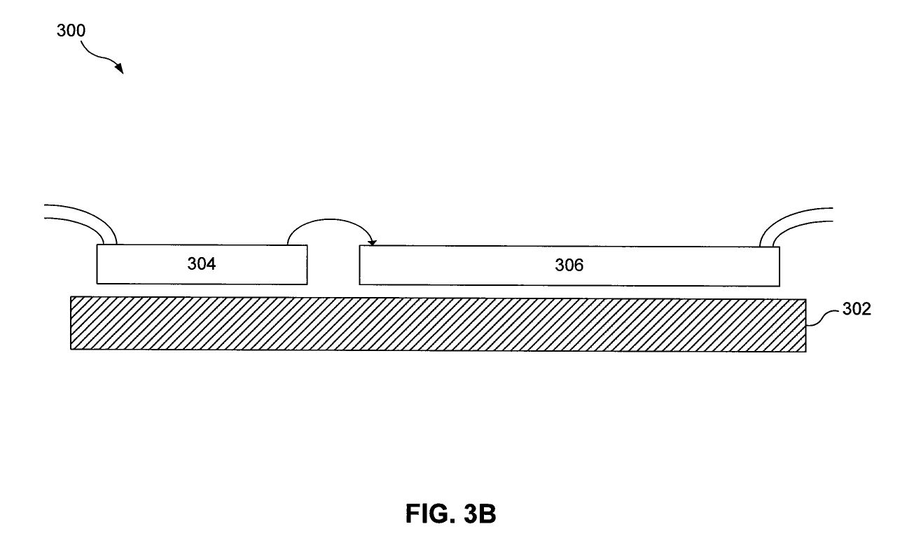

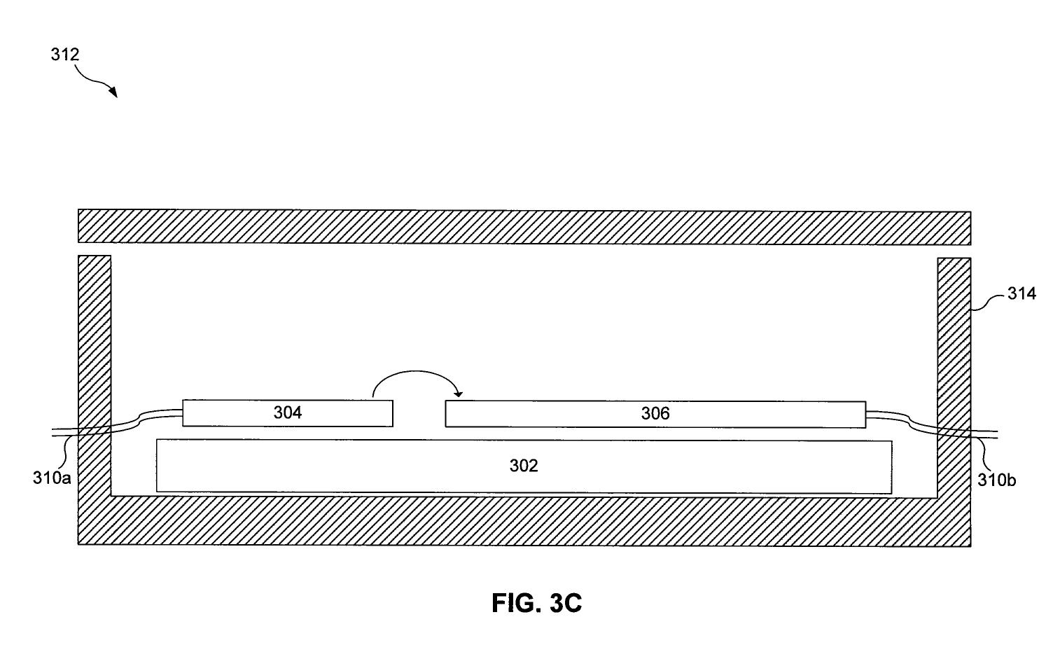

FIG. 3A illustrates a set-top box assembly 300 having a tuner IC 304 and a set-top box IC 306 that are mounted on a common carrier 302, according to an embodiment of the invention. The set-top box assembly 300 has a reduced level of integration relative to the set-top box 200, but this is not apparent to the end-user. Namely, the set-top box IC 306 includes an up-stream power amplifier 308 on the same substrate with the digital set-top box functions 110-144, similar to the set-top box IC 202. However, the tuner IC 304 is a separate substrate from that of the set-top box IC 306, but is mounted on the common carrier 302. The common carrier 302 can be made of fiberglass or FR-4, or some other type of known electronic PC board material. The common carrier 302 can be used to route signals between the various components of the set-top box assembly 300. For instance, the common carrier 302 can include conductive traces to route signals between the tuner IC 304 and the set-top box IC 306.

FIG. 3B further illustrates the set-top box 300. Namely, FIG. 3B illustrates a side view of the set-top box 300 with the TV tuner 304 and the set-top box IC 306 mounted on the common carrier 302. The TV tuner 304 and the set-top box IC 306 can be attached to the common carrier 302 using standard adhesive techniques that are used in the electronics industry. As shown in FIG. 3C, the common carrier 302 with the TV tuner 304 and the set-top box IC 306 can be mounted in a standard semiconductor package 314 (e.g., a plastic semiconductor package) with leads 310a and 310b extending through the plastic package 314. Once assembled, the set-top box 312 in FIG. 3C appears as a single chip device to a user, even though the tuner IC 304 is a separate IC from the set-top box IC 306.

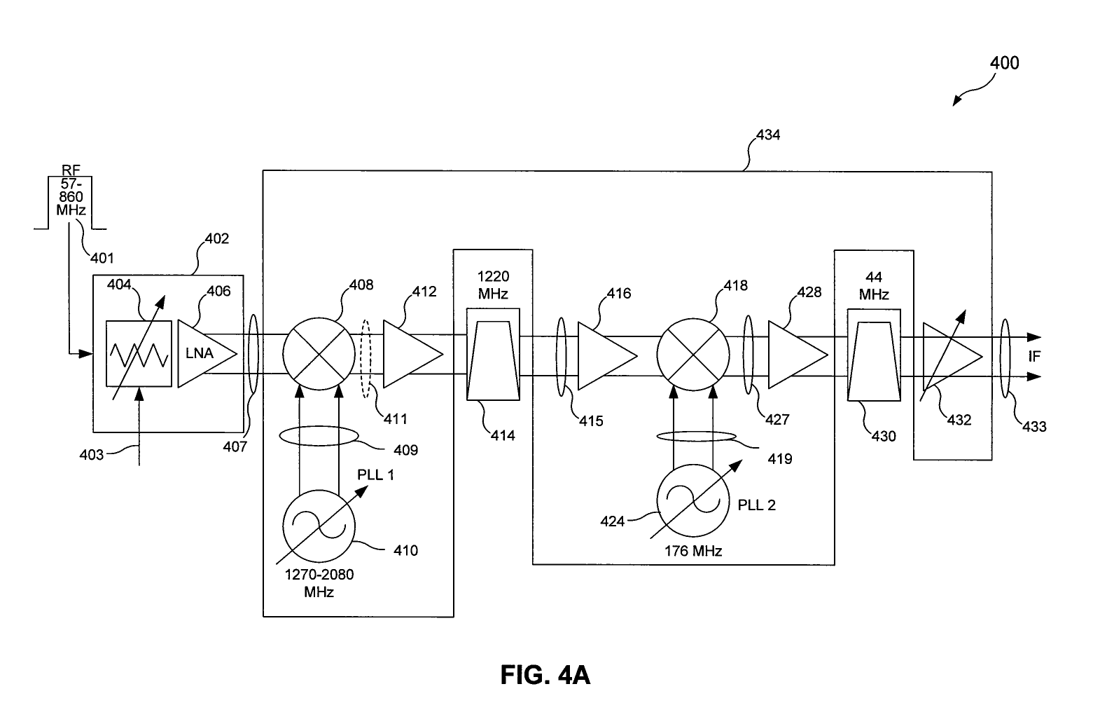

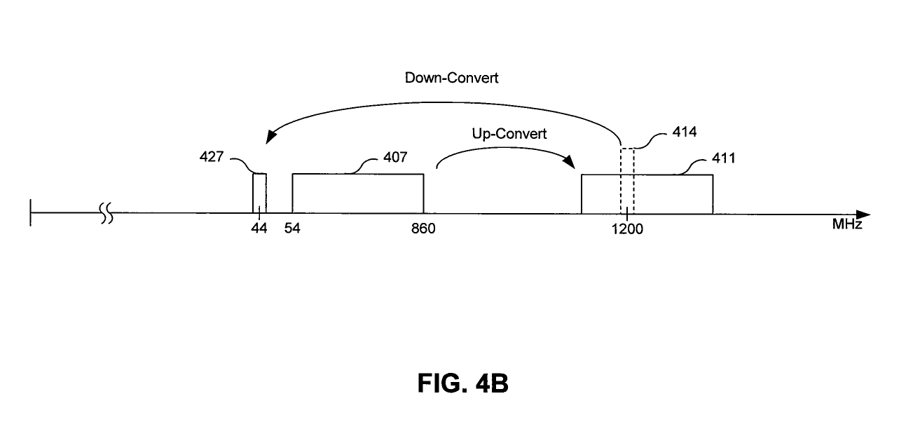

In one embodiment, the tuners 204 and 304 are a dual conversion tuner. For example, FIG.4A illustrates a schematic of a tuner assembly 400 that has an (optional) automatic gain control circuit (AGC) 402 and a tuner 434. The optional AGC 402 can be on a separate substrate as shown or on a common substrate with the tuner 434, or the tuner 434 can be used without the AGC 402.

The tuner assembly 400 receives an RF input signal 401 having multiple channels and down-converts a selected channel to an IF frequency, to produce an IF signal 433. For instance, the RF input signal 401 can include multiple TV channels that typically have 6 MHz frequency spacings and cover a range of 54-860 MHz, and where the selected channel is down-converted to an IF frequency at 44 MHz, 36 MHz or some other desired IF frequency for further processing. The frequencies listed herein are not meant as a limitation and are provided for example purposes only. The structure and operation of the tuner assembly 400 are described in further detail below.

The AGC circuit 402 provides automatic gain control using a variable resistor network 404 and a low noise amplifier (LNA) 406. The variable resistor network 404 attenuates the RF input signal 401 according to a control signal 403. In embodiments, the control signal 403 is based on the signal amplitude of the IF signal 433, so that the RF front-end gain can be adjusted to achieve a desired amplitude for the IF signal 433. The LNA 406 provides low noise amplification and converts a single-ended input signal to a differential RF signal 407.

Tuner 434 is one embodiment of the tuner ICs 204 and 304 that are shown in FIGS. 2 and 3, respectively. The tuner IC 400 has a dual conversion architecture (one up-conversion, and one down-conversion) that includes an up-convert mixer 408 and a down-convert mixer 418. The up-convert mixer 408 is driven by a first phase-locked loop (PLL) 410 that has coarse tuning capability from 1270-2080 MHz. The down-convert mixer 418 is driven by a second PLL 424 that has a relatively fine tuning capability. Two separate off-chip surface acoustic wave (SAW) filters 414 and 430 are used to perform IF filtering in the tuner 434. However, other bandpass filters besides SAW filters could be used for the filters 414 and 430, as will be understood by those skilled in the arts. The first SAW filter 414 is connected between the up-convert mixer 408 and the down-convert mixer 418. The passband of the SAW filter 414 is centered at 1220 MHz, and is preferably only a few channels wide (e.g., 1-2 channels wide or 12 MHz for 6 MHz TV channel spacings), and can be referred to as a channel selection filter. The second SAW filter 430 has a passband at 44 MHz and is coupled to the output of the amplifier 428. Additionally, various on-chip amplifiers 412, 416, 428, and 432 are included throughout the tuner 434 to provide signal amplification, as necessary.

The SAW filters 414 and 430 could be implemented on the carrier 302 of the set-top box 300 that is shown in FIG.3C. Alternatively, equivalent on-chip bandpass filters using lumped elements could be fabricated on-chip.

The operation of the tuner 434 is described as follows and in reference to FIG. 4B, where FIG. 4B represents the frequency spectrum of the particular signals that are operated on and generated by the tuner 434. The up-convert mixer 408 mixes the RF signal 407 with a LO signal 409 that is generated by the PLL 410. As discussed above and as shown in FIG. 4B, the RF signal 407 can be a TV signal having a plurality of channels that occupy a frequency range from 54 MHz to 860 MHz. Since the PLL 410 is tunable from 1270 to 2080 MHZ, the RF signal 407 is up-converted to a first IF 411 having a frequency that is above the 54-860 MHZ input frequency band. The first IF 411 is sent off-chip to the SAW filter 414, which has a narrow passband window centered at 1220 MHz, as discussed above. The first SAW filter 414 selects a desired channel 415 that is within its narrow passband window, and substantially rejects all of the remaining channels, including an image channel or frequency. Therefore, a particular channel is selected by varying the frequency of the LO signal 409 so that the desired channel is up-converted into the narrow passband of the IF filter 414. The desired channel 415 (at 1220 MHZ) is sent back on-chip to the PGA 416, where the PGA 416 provides gain for the selected channel 415. The down-convert mixer 418 mixes the output of the PGA 416 with an LO signal 419 from the PLL 424. The down-convert mixer 418 down-converts the desired channel 415 to a 44 MHz IF signal 427 that appears at the IF output of the down-convert mixer 418. Finally, the IF signal 427 is filtered a second time by the bandpass SAW filter 430 to reject any unwanted frequency harmonics, producing the output IF signal 433 at 44 MHz, or some other desired IF frequency or baseband, and carrying the information in the desired channel.

The specific frequencies mentioned in the description of the tuner assembly 400, and throughout this application, are given for example purposes only and are not meant to be limiting. Those skilled in the arts will recognize other frequency applications for the tuner assembly 400 based on the discussion given herein. These other frequency applications are within the scope and spirit of the present invention.

Furthermore, it is noted that the tuner assembly 400 is configured for differential operation. For instance, the first mixer 408, the bandpass filter 414, the second mixer 418, the first LO signal 409, and the second LO signal 419 are all configured with differential inputs and outputs to reduce signal distortion. However, the present invention is not limited to differential operation, and can be implemented in single ended configurations.

In another embodiment, the tuners 204 and 304 are implemented as a direct conversion digital tuner. For example, a direct sampling tuner includes a low noise amplifier (LNA) and an optional dynamically configurable band pass filter coupled to the low noise amplifier. The optional filter is configured to pass a selected band of channels. The tuner further includes a relatively high accuracy, multi-bit analog-to-digital converter (“ADC”) coupled to the LNA or to the optional dynamically configurable band pass filter. The ADC operates at greater than twice a frequency of a sampled signal. The ADC directly samples the spectrum of the selected channels at the Nyquist frequency, thus avoiding image problems presented by conventional tuners. The direct conversion digital tuner is further described in U.S. application Ser. No. 10/952,168, titled “Direct Digital Conversion Tuner and Method for Making the Same, filed on Sep. 29, 2004, which is incorporated herein by reference in its entirety. Furthermore, the high accuracy, multi-bit ADC is further described in U.S. patent application Ser. No. 10/085,071, which is incorporated herein by reference in its entirety.

In another embodiment, the tuners 204 and 304 are single conversion tuners that down-convert the RF input signal to an IF or a baseband signal that is then digitized. In yet another embodiment, the tuners 204 and 304 are quadrature direct conversion tuner that are capable of down-converting a quadrature signal directly to baseband and also performing A/D conversion and demodulation. The quadrature direct conversion tuner also removes the need for an off-chip channel selection filter, because the down-conversion is directly to baseband without an intermediate frequency. The quadrature direct conversion tuner can also correct any I/Q errors between the in-phase and quadrature channels, and also as any frequency errors.

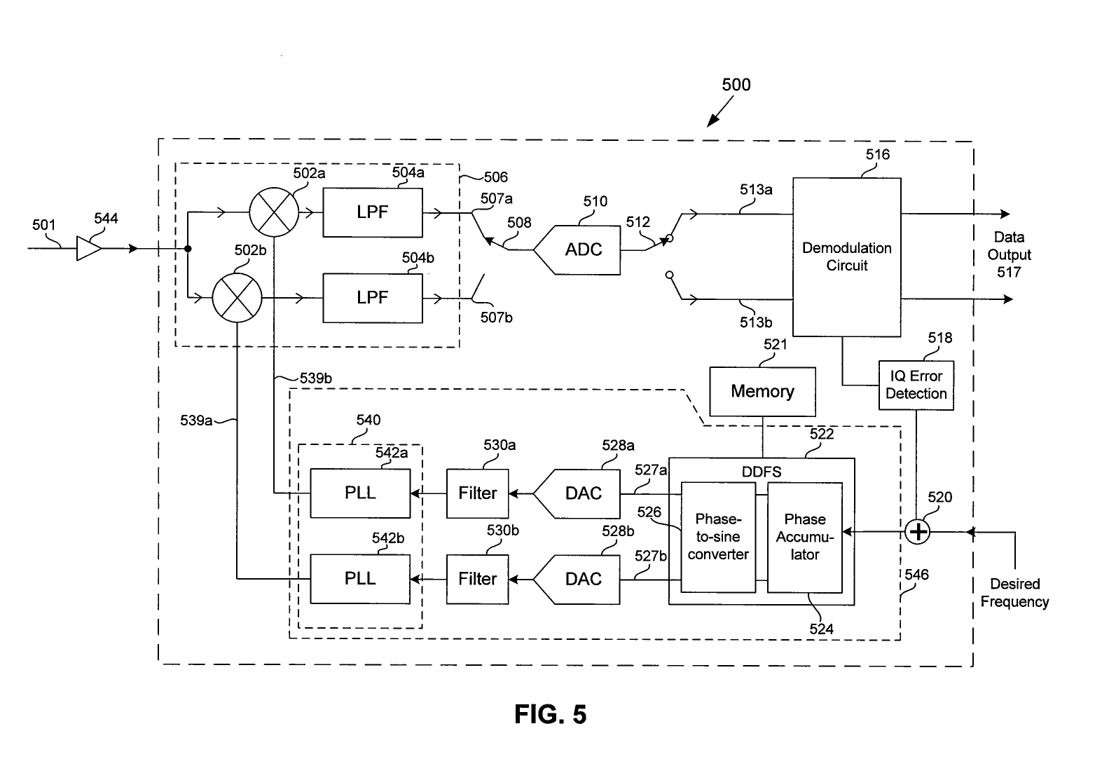

FIG. 5 illustrates a quadrature direct conversion tuner 500 in which quadrature components of a local oscillator signal are independently generated according to an embodiment of the present invention. The tuner 500 is one embodiment of the tuner that can be used in integrated set-top boxes 200 and 300. The tuner 500 includes a direct down conversion circuit 506, an analog-to-digital converter 510, a demodulation circuit 516, a memory 521, an I/Q Error Detection circuit 518, and a local oscillator circuit 546. The direct down-conversion circuit 506 includes quadrature mixers 502a and 502b, and lowpass filters 504a and 504b. The local oscillator circuit 546 includes: a DDFS 522 having a phase accumulator 524 and a phase-to-sine converter 526, digital-to-analog converters 528a and 528b, filters 530a and 530b, and a PLL 540. A low noise amplifier 544 may be included off-chip, on a separate substrate.

During operation, the direct down conversion circuit 506 receives a RF input signal 501. The RF input signal 501 is generally amplified by the low-noise amplifier 544. For instance, a discrete low-noise amplifier, such as Broadcom part number BCM 3405, can be coupled to the input of the quadrature direct down conversion circuit 506. In an alternate embodiment, the amplifier 544 is integrated on-chip with the quadrature direct down-conversion circuit 506.

The mixers 502a and 502b mix the RF input signal 501 and a quadrature local oscillator signal 539 to provide a down-converted signal. More specifically, mixer 502a mixes the RF input signal 501 and a first quadrature component 539a of the local oscillator signal to provide a first down-converted quadrature component 507a. Mixer 502b mixes the RF input signal 501 and a second quadrature component 539b of the local oscillator signal to provide a second down-converted quadrature component 507b. The first and second quadrature components 507a and 507b can be at baseband or a low frequency IF depending on the operating frequency of the local oscillator. One or more low pass filters (LPFs) 504 can be included to reduce or eliminate unwanted signal energy.

A multiplexer 508 selects the first down-converted quadrature component 507a or the second down-converted quadrature component 507b to be sent to the analog-to-digital converter (ADC) 510. The receiver 500 includes a single ADC 510 for illustrative purposes, though the scope of the present invention is not limited in this respect. Separate ADCs could be used for the quadrature channels. However, a single ADC does not cause gain and/or linearity mismatches between the quadrature components that can occur when two ADCs are utilized. Further, a single ADC reduces the size of the tuner 500, as compared to using two ADCs.

The multiplexer 508 interleaves samples of the first down-converted quadrature component 507a and the second down-converted quadrature component 507b to provide an interleaved sample of the down-converted quadrature components to the ADC 510. In one embodiment, the multiplexer 508 toggles at a rate equal to at least twice the effective sampling rate of the ADC 510, so that both quadrature components can be adequately sampled. For example, sampling at this rate can facilitate accurate conversion of the down-converted quadrature components 507a and 507b by the ADC 510.

The ADC 510 converts the interleaved sampling of the down-converted quadrature components into a digital signal. According to an embodiment, the sampling rate of the ADC 510 equals the interleaving rate of the multiplexer 508 plus an over sampling ratio. By oversampling, the ADC 510 can extend the noise performance of the ADC 510 and/or reduce the number of bits required by the ADC 510.

A demultiplexer 512 de-interleaves the digital samples of the down-converted quadrature components provided by the ADC 510 to provide quadrature digital signals 513a and 513b. In an embodiment, the de-multiplexer 512 toggles at a rate equal to the toggle rate of the multiplexer 508.

The demodulation circuit 516 receives quadrature digital signals 513a and 513b and provides a demodulated signal 517. The demodulated signal 517 is a data output that can be further processed for audio/video display, etc. In an embodiment, the demodulation circuit 516 is a quadrature amplitude modulation (QAM) demodulation circuit. For example, the demodulation circuit 516 can include a Nyquist filter, a variable rate symbol demodulator, an equalizer, and a carrier recovery loop (all not shown for convenience).

An I/Q error detection circuit 518 is coupled to the demodulation circuit 516 and determines an amplitude and/or phase error between the I and Q channels. The I/Q error detection circuit 518 can also include a carrier tracking loop that determines any frequency error in the down-converted signals 507a and 507b, which can then be corrected by the local oscillator circuit 546. The I/Q error detection circuit 518 forwards the I/Q error to a summer 520, which also receives a desired frequency for down-conversion. The desired frequency identifies the desired frequency or channel that is to be selected from the RF input signal 501. The local oscillator circuit 546 then sets the frequency of the local oscillator signal based on the selected channel of the RF input signal 501. The local oscillator circuit 546 also adjusts quadrature LO components 539a and 539b so as to correct any I/Q amplitude or phase errors, as discussed further below.

The local oscillator circuit 546 includes a Direct Digital Frequency Synthesizer (DDFS) 522 and a memory 521 to generate a digital representation of the local oscillator signal. The memory 521 stores a read-only memory (ROM) lookup table. The ROM lookup table includes a plurality of entries, where each entry represents a phase of the local oscillator signal or a sine or cosine thereof. The DDFS 522 can retrieve an entry from the ROM lookup table at each cycle or half-cycle of the VCO clock, for example, to provide the digital representation of the local oscillator signal.

The DDFS 522 generates a digital sinewave having I/Q components based on the desired channel input from the summer 520. The DDFS 522 digitally converts phase information relating to the local oscillator signal to a digitized sinusoidal waveform. The DDFS 522 receives the phase information from the memory 521. The DDFS 522 provides faster frequency switching, lower phase noise, and/or higher frequency resolution, as compared to standard phase-locked loop (PLL) frequency synthesizers.

The DDFS 522 includes a phase accumulator 524 to receive phase information relating to the local oscillator signal with each successive clock cycle of the local oscillator circuit 546. For example, the phase accumulator 524 can receive first phase information during a first clock cycle, and second phase information during a second clock cycle, and so on.

The DDFS 522 further includes a phase-to-sine converter 526 to convert phase information received from the memory 521 into a digitized sinusoidal waveform. For example, the phase-to-sine converter 526 can provide a first waveform representing the sine of the phase information and a second waveform representing the cosine of the phase information. The first waveform is a first quadrature component 527a of the local oscillator signal, and the second waveform is a second quadrature component 527b of the local oscillator signal, wherein the first and second components are digital representations of the local oscillator signal.

According to another embodiment, the memory 521 also stores a frequency offset value. For example, the offset value can indicate a difference between the actual frequency of the local oscillator signal and the desired frequency of the local oscillator signal. The frequency of the local oscillator signal can be set based on the offset value. For instance, the offset value can be combined with the local oscillator signal to provide a frequency-shifted local oscillator signal.

The memory 521 can also store a phase offset that indicates a phase difference between quadrature components of the local oscillator signal, determined by the demodulation circuit 516, for example. The offset value can be used to adjust the phase of at least one of the quadrature components of the local oscillator signal. Utilizing the offset value to correct the phase difference between the quadrature components of the local oscillator signal can eliminate the need for other quadrature correcting circuitry or software. For example, correcting the quadrature of the local oscillator signal using the DDFS 522 can reduce the number of components needed in the receiver 500, thereby reducing the cost of the receiver in an embodiment.

In summary, the quadrature components of the local oscillator signal are generated independently in accordance with the embodiment shown in FIG. 5. Therefore, the DDFS 522 reduces any gain mismatch or phase mismatch between the quadrature components.

The frequency of the local oscillator signal can be based on a frequency control word associated with the local oscillator signal. For instance, a clock signal can be multiplied by the frequency control word to calculate the frequency of the local oscillator signal. The offset value stored in the memory 521 can be used to calculate the frequency control word associated with the local oscillator signal. In an embodiment, the offset value is used to set the frequency of at least one of the quadrature components of the local oscillator signal.

According to another embodiment, the receiver 500 includes two DDFSs. For instance, a first DDFS can be used to convert phase information relating to a first quadrature component of the local oscillator signal to a first digitized sinusoidal waveform. The second DDFS can be used to convert phase information relating to a second quadrature component of the local oscillator signal to a second digitized sinusoidal waveform.

The digital representations 527 of the local oscillator quadrature components are provided to digital-to-analog converters (DACs) 528. The DACs 528 can convert the digital representations into analog local oscillator signals. For instance, the DACs 528 can directly generate the analog local oscillator signals. Alternatively, the DACs 528 can generate reference signals, which can be used by phase-locked loops (PLLs), such as PLLs 542, to generate the analog local oscillator signals 539a and 539b as shown in FIG. 5.

Filters 530 are coupled to the output of the DACs 528 so as to reduce or eliminate unwanted frequencies from the quadrature local oscillator signals. The filters 530 can be low pass filters or bandpass filters. According to an embodiment, the filters 530 are narrow-band bandpass filters. For direct conversion, the filters 530 can be set at a particular frequency or range of frequencies that represents the desired channel of the RF input signal. In a first embodiment, the passband of the filters 530 are tunable and set based on the frequency of the local oscillator signal set by the local oscillator circuit 546. In a second embodiment, the passband of the filters 530 are set at a predetermined frequency or range of frequencies, and the local oscillator circuit 546 manipulates the frequency of the local oscillator signal to be within the passband of the filters 530. For example, the local oscillator circuit 546 can multiply the frequency of the local oscillator signal by a factor based on the selected channel of the RF input signal 501.

Phase Lock Loops (PLL) 542 are coupled to the outputs of the filters 530, and provide the quadrature components 539a and 539b of the local oscillator signal to the direct down conversion circuit 506 to be mixed with the RF input signal 501. A PLL 542 is included for each quadrature component of the local oscillator signal. However, a single PLL can be used to filter both quadrature components.

The PLLs 542 can multiply the frequency of the local oscillator signal by a predetermined factor. For example, the PLL 542 can multiply the frequency of the local oscillator signal by a factor in the range from approximately two to approximately thirty. Other factors could be used. The PLLs 542 can increase the frequency of the local oscillator signal by a factor of six in a set-top box system, for example. The PLLs 542 can increase the frequency of the local oscillator signal by a factor of twelve in a satellite communication system, to provide another example.

Using the PLLs 542 to multiply the frequency of the local oscillator signal by a fixed value allows the DACs 528 to sample at a lower rate. For example, the sampling rate of the DACs 528 is decreased by a factor that is proportional to the factor by which the frequency of the local oscillator is multiplied in an embodiment. Using the PLLs 528 to multiply the frequency of the local oscillator signal by a fixed value can enable the size of the PLLs 528 to be reduced, as compared to the situation in which the PLLs 528 are used to multiply the frequency of the local oscillator by a variable factor to generate the frequency of the local oscillator signal.

According to an embodiment of the present invention, the direct down conversion circuit 506, the demodulation circuit 516, and the local oscillator circuit 546 are on a common substrate. One or more of the multiplexer 508, the ADC 510, the demultiplexer 512, the DAC 528, the memory 521, I/Q correction circuit 518, and the filters 530 can be on the common substrate, as well. Combining elements, such as those mentioned above, on a common substrate reduces the cumulative circuit area required by the elements, and therefore the overall chip cost.

The quadrature direct conversion tuner 500 is further described in U.S. patent application Ser. No. 10/902,477, titled “Apparatus and Method for Integration of Tuner Functions in a Digital Receiver, Atty. Doc. No. 1875.5870000, which is incorporated by reference herein in its entirety.

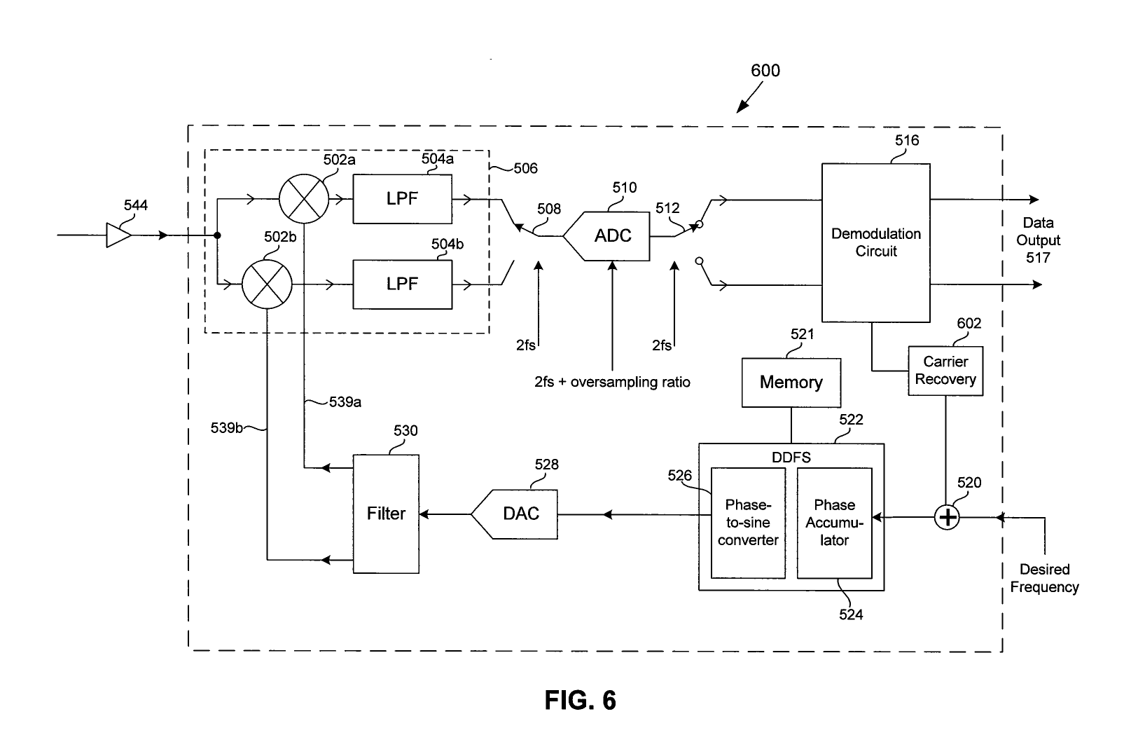

FIG. 6 illustrates a further tuner embodiment 600, that uses a single DAC 528, and a carrier recovery loop 602 instead of an I/Q error detection circuit. The carrier recovery loop 602 determines any frequency offset between the I/Q channels. Accordingly, the tuner 600 is only capable of making frequency corrections to the local oscillator signals 539 and cannot make I/Q phase corrections. However, the signal DAC 528 utilizes less substrate area.

As discussed above in reference to FIG. 3A, the up-stream power amplifier is also integrated on chip. The integration of the up-stream power amplifiers 206 and 308 are further described in U.S. patent application Ser. No. 10/163,313, which is incorporated by reference herein in its entirety. For example, an up-stream amplifier is integrated on a substrate with a digital-to-analog converter (DAC). In an embodiment, a low-pass filter is also integrated on the substrate. The output signal level of the up-stream amplifier is controllable. In embodiments, fine adjustments are made to the output signal level of the up-stream amplifier by varying a bias current of the DAC. A software control bit is used to switch between a power-on mode of operation and a power-down mode of operation. The up-stream amplifier transmits in a burst mode. The power consumption of the up-stream amplifier scales with the amplifier's output signal level. A high degree of matching is attained between the positive and negative paths of the up-stream amplifier. This provides high immunity from common-mode disturbances such as substrate noise, clock spurs, and glitches caused by a gain change.

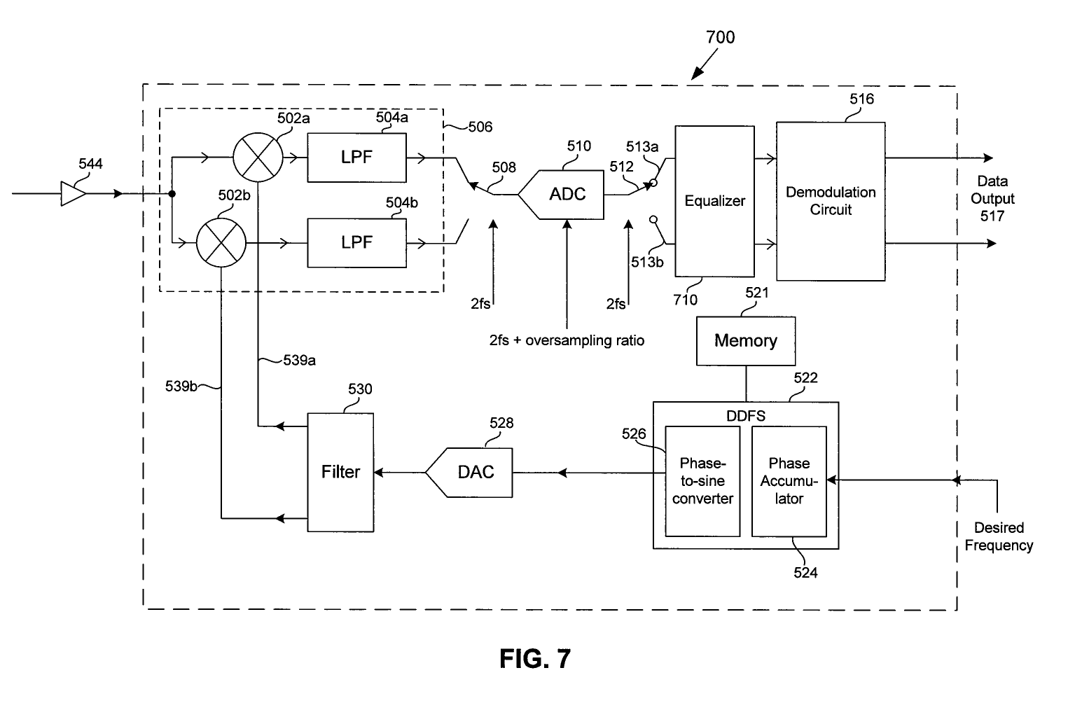

FIG. 7 illustrates a quadrature direct conversion tuner 700 having a baseband equalizer 710 according to an embodiment of the present invention. In embodiments, the baseband equalizer 710 is an asymmetric equalizer that is used to correct I/Q errors.

Quadrature paths of the tuner 700 are generally not completely isolated from each other. For instance, a first quadrature component traveling along a first path 513a can include information from a second quadrature component traveling along a second path 513b, and vice versa. The baseband equalizer 710 can determine how much information from one quadrature component is included in the other quadrature component, and vice versa. The baseband equalizer 710 generally subtracts the second quadrature component information or a portion thereof from the first quadrature component. The baseband equalizer 710 typically subtracts the first quadrature component information or a portion thereof from the second quadrature component.

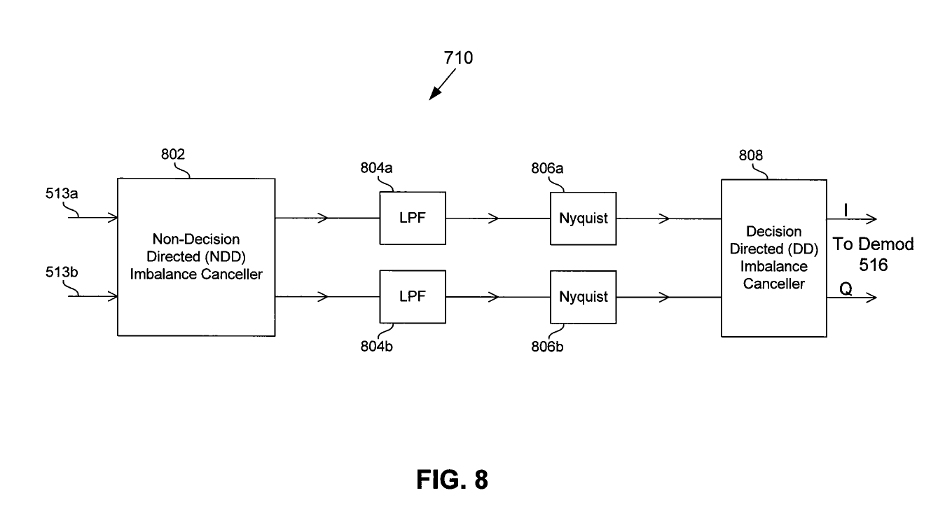

FIG. 8 further illustrates the baseband equalizer 710. Referring to FIG. 8, the equalizer 710 is a two stage equalizer having a non-decision directed (NDD) imbalance canceller 802, low pass filters 804, Nyquist filters 806, and a decision directed (DD) imbalance canceller 808. In embodiments, the NDD imbalance canceller 802 is a DC I/Q Imbalance Canceller that corrects for gain and phase imbalance. Whereas, the DD imbalance canceller 808 is an asymmetric equalizer that corrects for any type of UQ imbalance, including sampling imbalance.

The equalizer 710 is further described in U.S. Provisional Patent Application No. 60/661,165, filed on Mar. 14, 2005, which is incorporated herein by reference.

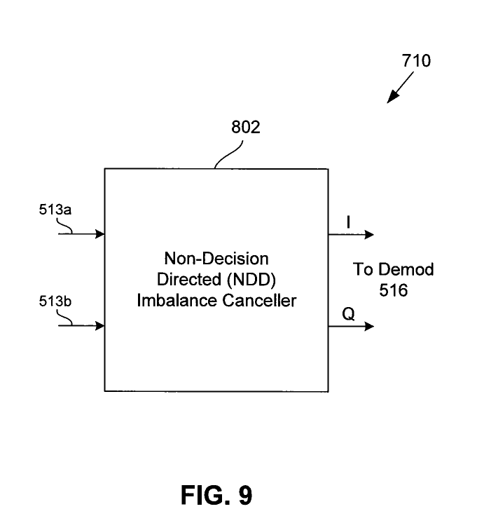

FIG. 9 illustrates a second embodiment of the equalizer 710, the equalizer having only the non-decision directed stage 802. The I/Q imbalance correction is still accomplished with the NDD imbalance canceller 802.

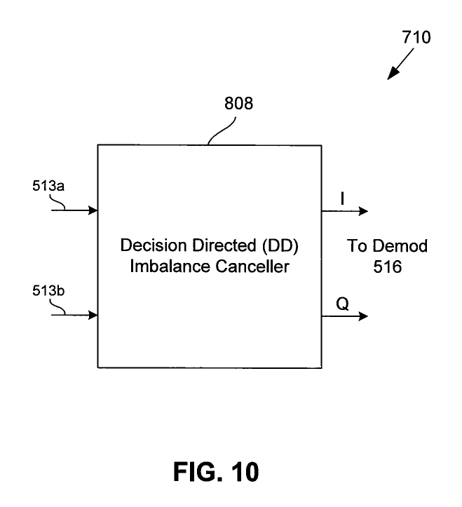

FIG. 10 illustrates a third embodiment of equalizer 710, the equalizer having only a decision directed stage 808. The I/Q imbalance correction is still accomplished with the DD imbalance canceller 808.

Further information with regard to the above disclosure can be found in U.S. Patent Application Publication No. 2006/0026661 A1 (U.S. patent application Ser. No. 11/133,237, filed May 20, 2005), which is incorporated herein by reference in its entirety.

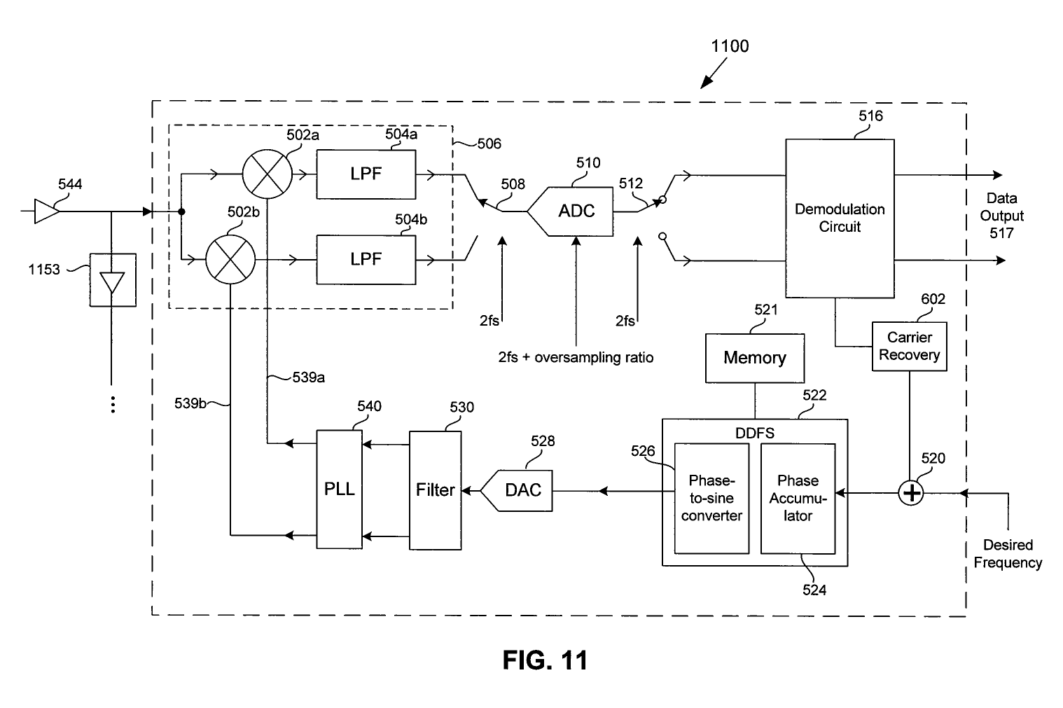

FIG. 11 illustrates a direct-conversion tuner 1100 and a daisy-chain buffer 1153 for cascading of additional receiving devices, according to an embodiment of the present invention. The daisy-chain buffer can follow an amplifier, such as low-noise amplifier (LNA) 544, and can provide the output of LNA 544 to one or more receiving devices in addition to tuner 1100. In embodiments, the one or more additional receiving devices can include, but are not limited to, a set-top box, an integrated tuner, an isolated tuner, a television, and a cable.

Providing the daisy-chain buffer 1153 following the LNA 544 allows the benefits of LNA 544 on the daisy-chain, while allowing multiple devices to be cascaded together without the added costs of using multiple low noise amplifiers (LNAs) or a more expensive LNA with multiple outputs. The provided advantages include a lower bill of materials cost, less power consumption, and a reduction of system complexity.

In an embodiment, if tilt compensation is desired, then there can be tilt compensation in LNA 544 and additional tilt compensation in daisy-chain buffer 1153. With tilt compensation, line tilt is removed from a signal (e.g., a video signal) by applying a gain ramp. Coaxial cable has a frequency response, and the higher the frequency the more loss. In long cables provided to houses, for example, the high frequencies are attenuated more. To compensate for the loss, a programmable feature can be added to the LNA that can boost the gain and decrease the noise figure at high frequencies. The gain slopes upward versus frequency to compensate for a downward cable tilt. This can be done in LNA 544 and also separately in daisy-chain buffer 1123, by increasing the gain at the higher frequencies versus the lower frequencies.

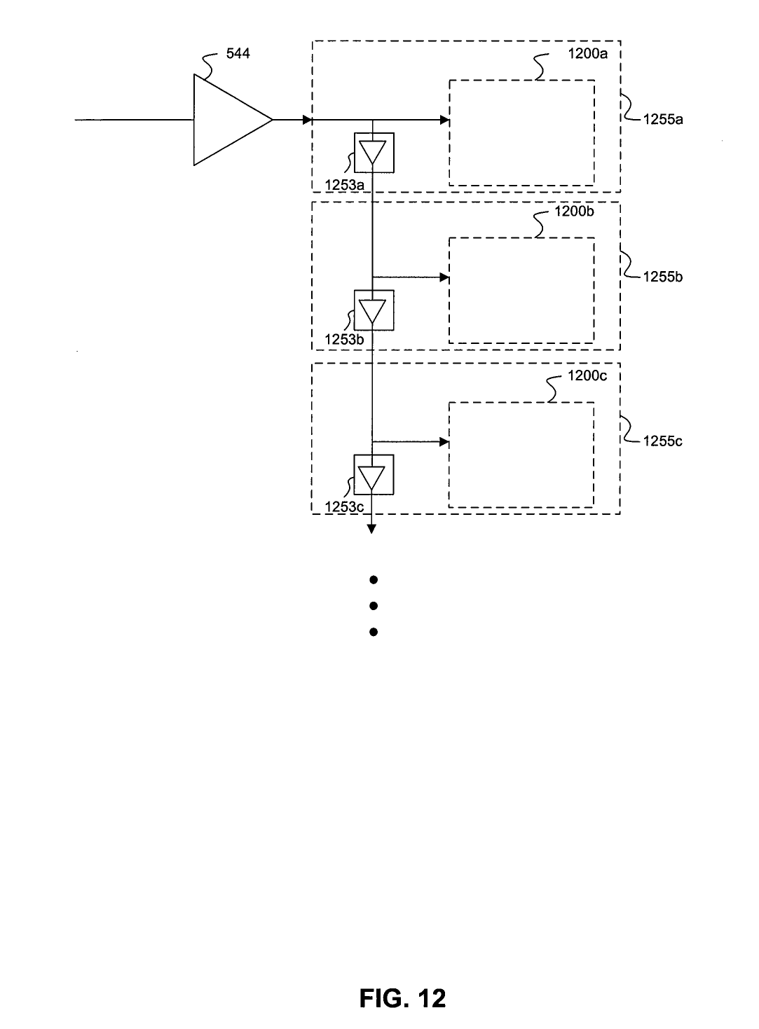

In an embodiment shown in FIG. 12, a daisy-chain buffer is disposed on the same substrate as a corresponding tuner. In FIG. 12, tuners 1200a, 1200b, and 1200c are daisy-chained via corresponding daisy-chain buffers 1253a and 1253b. Daisy-chain buffer 1253a is disposed on a same substrate 1255a as tuner 1200a, and daisy-chain buffer 1253b is disposed on a same substrate 1255b as tuner 1200b. Daisy-chain buffer 1253c is disposed on a same substrate 1255c as tuner 1200c and can be used to daisy-chain additional set-top boxes or other receiving entities.

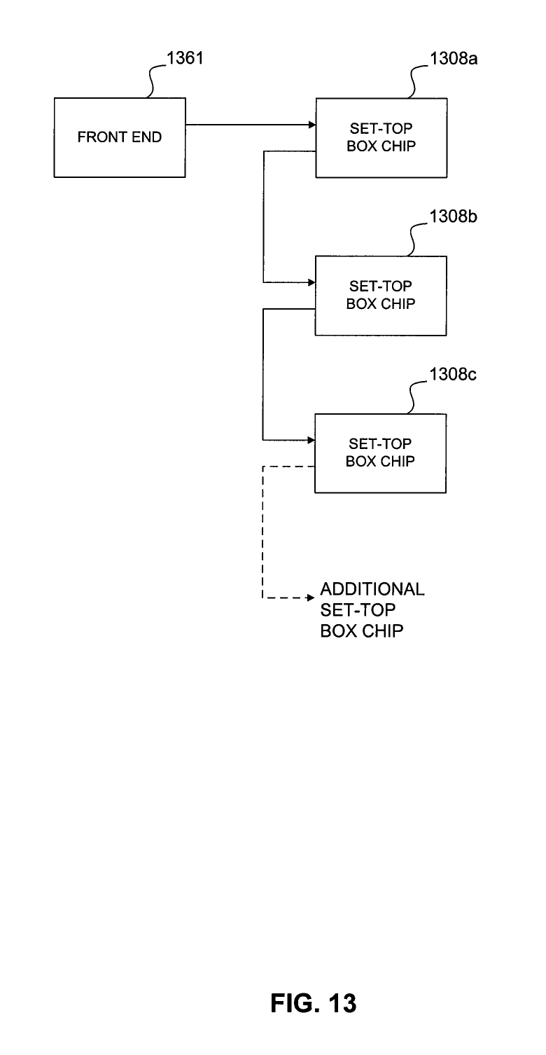

Daisy-chain buffers as described herein can be used to daisy-chain two or more set-top boxes as shown in FIG. 13, according to an embodiment. In FIG. 13, set-top boxes 1308a, 1308b, and 1308c are daisy-chained together. A front-end circuit 1361 is depicted in the embodiment shown in FIG. 13. By daisy-chaining the set-top boxes, only a single front-end circuit 1361 is needed, reducing both cost and space.

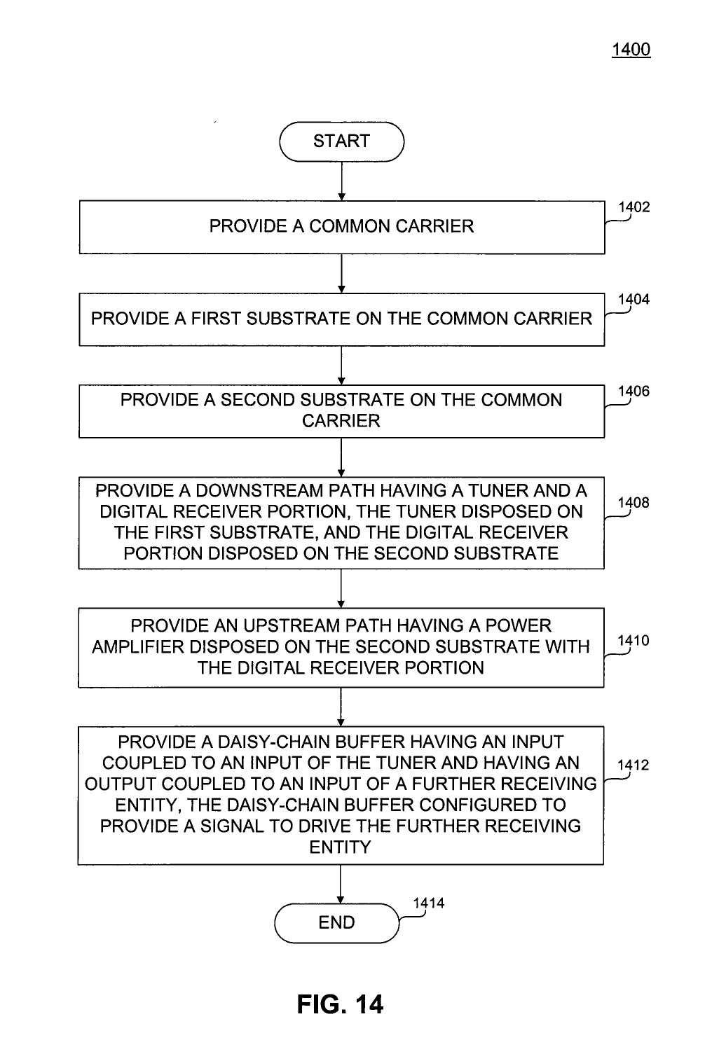

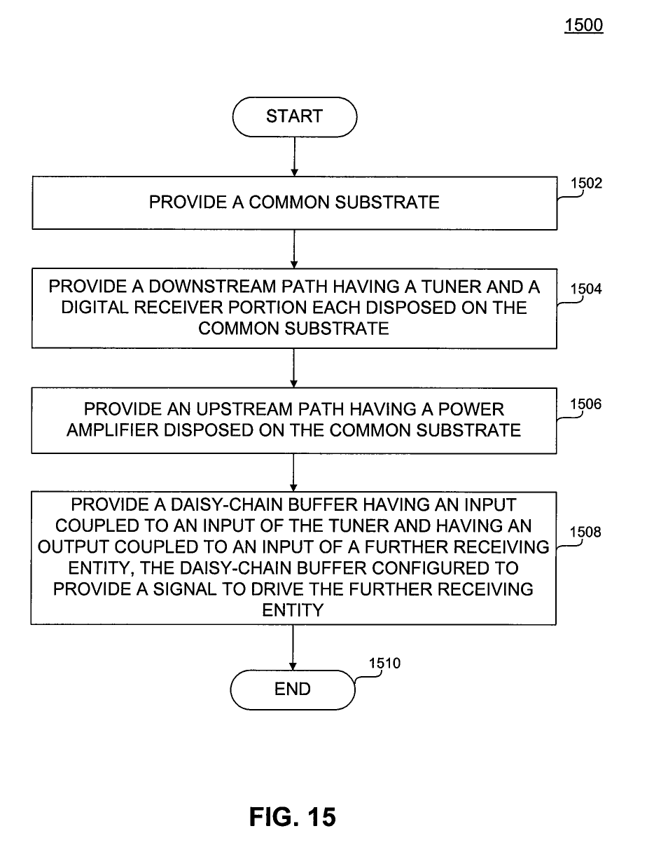

FIGS. 14 and 15 are flowcharts illustrating methods of manufacturing a set-top box. In method 1400 shown in FIG. 14, a tuner is disposed on a first substrate, a digital receiver portion and a power amplifier are disposed on a second substrate, and the first and second substrates are provided on a common carrier. In method 1500 shown in FIG. 15, a tuner, a digital receiver portion, and a power amplifier are disposed on a common substrate. Daisy-chaining capability is provided in each case.

In FIG. 14, method 1400 begins at step 1402 in which a common carrier is provided. In step 1404, a first substrate is provided on the common carrier. In step 1406, a second substrate is provided on the common carrier. In step 1408, a downstream path having a tuner and a digital receiver portion is provided, where the tuner is disposed on the first substrate, and the digital receiver portion is disposed on the second substrate. In step 1410, an upstream path including a power amplifier is provided, where the power amplifier is disposed on the second substrate with the digital receiver portion. In step 1412, a daisy-chain buffer is provided having an input coupled to an input of the tuner and having an output coupled to an input of a further receiving entity. The further receiving entity can include, but is not to be limited to, a set-top box, an integrated tuner, an isolated tuner, a television, a cable, etc. The daisy-chain buffer is configured to provide a signal to drive the further receiving entity. Method 1400 ends at step 1414.

In FIG. 15, method 1500 begins at step 1502 in which a common substrate is provided. In step 1504, a downstream path having a tuner and a digital receiver portion is provided, where the tuner and digital receiver portion are disposed on the common substrate. In step 1506, an upstream path including a power amplifier is provided, where the power amplifier is disposed on the common substrate. In step 1508, a daisy-chain buffer is provided having an input coupled to an input of the tuner and having an output coupled to an input of a further receiving entity. The receiving entity can include, but is not to be limited to, a set-top box, an integrated tuner, an isolated tuner, a television, a cable, etc. The daisy-chain buffer is configured to provide a signal to drive the further receiving entity. Method 1500 ends at step 1510.

### Conclusion

Example embodiments of the methods, systems, and components of the present invention have been described herein. As noted elsewhere, these example embodiments have been described for illustrative purposes only, and are not limiting. Other embodiments are possible and are covered by the invention. Such other embodiments will be apparent to persons skilled in the relevant art(s) based on the teachings contained herein. Thus, the breadth and scope of the present invention should not be limited by any of the above-described exemplary embodiments, but should be defined only in accordance with the following claims and their equivalents.

What is claimed is:

1. A set-top box, comprising:
a common carrier;
a down-stream path having a tuner and a digital receiver portion, the tuner disposed on a first substrate attached to the common carrier, and the digital receiver portion disposed on a second substrate attached to the common carrier;
an up-stream path having a power amplifier disposed on the second substrate with the digital receiver portion; and
a daisy-chain buffer having an input coupled to an input of the tuner and having an output coupled to an input of a further receiving entity, the daisy-chain buffer configured to provide a signal to drive the further receiving entity.

2. The set-top box of claim 1, wherein the further receiving entity is one or more of another set-top box, an integrated tuner, an isolated tuner, a television, and a cable.

3. The set-top box of claim 1, further comprising an amplifier having an output coupled to the input of the daisy-chain buffer.

4. The set-top box of claim 3, wherein the amplifier is a low noise amplifier.

5. The set-top box of claim 4, wherein the low noise amplifier includes tilt compensation.

6. The set-top box of claim 3, wherein the amplifier is disposed on the common carrier.

7. The set-top box of claim 3, wherein the amplifier is disposed on the first substrate.

8. The set-top box of claim 1, wherein the daisy-chain buffer is disposed on the first substrate.

9. The set-top box of claim 1, wherein the daisy-chain buffer includes tilt compensation.

10. A set-top box, comprising:
a common substrate;
a down-stream path having a tuner and a digital receiver portion each disposed on the common substrate;
an up-stream path having a power amplifier disposed on the common substrate; and
a daisy-chain buffer having an input coupled to an input of the tuner and having an output coupled to an input of a further receiving entity, the daisy-chain buffer configured to provide a signal to drive the further receiving entity.

11. The set-top box of claim 10, wherein the further receiving entity is one or more of another set-top box, an integrated tuner, an isolated tuner, a television, and a cable.

12. The set-top box of claim 10, further comprising an amplifier having an output coupled to the input of the daisy-chain buffer.

13. The set-top box of claim 12, wherein the amplifier is a low noise amplifier.

14. The set-top box of claim 13, wherein the low noise amplifier includes tilt compensation.

15. The set-top box of claim 12, wherein the amplifier is disposed on the common carrier.

16. The set-top box of claim 10, wherein the daisy-chain buffer includes tilt compensation.

17. A television receiver system, comprising:
two or more set-top boxes, each set-top box having
a common carrier;
a down-stream path having a tuner and a digital receiver portion, the tuner disposed on a first substrate attached to the common carrier, and the digital receiver portion disposed on a second substrate attached to the common carrier;
an up-stream path having a power amplifier disposed on the second substrate with the digital receiver portion; and
a daisy-chain buffer having an input coupled to an input of the tuner of the first set-top box and having an output coupled to an input of a second set-top box, the daisy-chain buffer configured to provide a signal to drive the second set-top box.

18. The television receiver system of claim 17, further comprising:
a front-end circuit configured to process the signal prior to providing the signal to one or more of the set-top boxes.

19. A television receiver system, comprising:
two or more set-top boxes, each set-top box having
a common substrate;
a down-stream path having a tuner and a digital receiver portion each disposed on the common substrate;
an up-stream path having a power amplifier disposed on the common substrate; and
a daisy-chain buffer having an input coupled to an input of the tuner of a first set-top box and having and output coupled to an input of a second set-top box, the daisy-chain buffer configured to provide a signal to drive the second set-top box.

20. The television receiver system of claim 19, further comprising:
a front-end circuit configured to process the signal prior to providing the signal to one or more of the set-top boxes.

21. A set-top box, comprising:
a tuner; and
a daisy-chain buffer configured to provide a signal to drive an additional receiving entity, the daisy-chain buffer having an input coupled to an input of the tuner and having an output capable of being coupled to an input of the additional receiving entity.

22. The set-top box of claim 21, wherein the additional receiving entity is one or more of another set-top box, an integrated tuner, an isolated tuner, a television, and a cable.
